(19) United States
(12) Patent Application Publication
(10) Pub. No.: US 2013/0311015 A1
(43) Pub. Date: Nov. 21, 2013

(54) VEHICLE AND CONTROL METHOD FOR VEHICLE

(71) Applicants: Hideaki Yaguchi, Toyota-shi (JP); Takeshi Hoshiba, Anjo-shi (JP); Akihiro Kimura, Toyota-shi (JP); Masahiro Naito, Anjo-shi (JP)

(72) Inventors: Hideaki Yaguchi, Toyota-shi (JP); Takeshi Hoshiba, Anjo-shi (JP); Akihiro Kimura, Toyota-shi (JP); Masahiro Naito, Anjo-shi (JP)

(73) Assignee: TOYOTA JIDOSHA KABUSHIKI KAISHA, Toyota-shi, Aichi-ken (JP)

(21) Appl. No.: 13/518,959

(22) PCT Filed: Feb. 3, 2011
(86) PCT No.: PCT/JP11/52224

§ 371 Date: Jun. 25, 2012

(51) Int. Cl. B60W 20/00; B60W 10/08; B60W 10/06

(52) U.S. Cl. CPC B60W 20/00; B60W 10/06; B60W 10/08; Y10S 903/93
USPC 701/22; 903/930

(57) ABSTRACT

A vehicle includes a start switch, an engine, and a first motor-generator coupled to a rotation shaft of the engine. Upon an operation of the start switch, the first motor-generator accelerates a rotational speed of the output shaft of the engine with a torque which decreases as a rotational speed of an output shaft of the first motor-generator increases.

### TECHNICAL FIELD

The present invention relates to a vehicle and a control method for a vehicle, and in particular to a technique of starting an internal combustion engine mounted on a vehicle.

### BACKGROUND ART

Japanese Patent Laying-Open No. 2007-23919 (PTL1) discloses an engine start control system disclosing a technique of restarting an engine when a push switch is pushed down even if a brake pedal is not depressed if the engine has stopped due to some cause while a vehicle is traveling.

In addition, in recent years, as one of the countermeasures against environmental problems, hybrid vehicles equipped with a motor-generator and an engine have received attention. A publicly known example of such hybrid vehicles is a vehicle with elements: drive wheels, an engine, and a motor-generator which are mechanically coupled together.

### CITATION LIST

### Patent Literature

PTL 1: Japanese Patent Laying-Open No. 2007-23919

### SUMMARY OF INVENTION

### Technical Problem

In the hybrid vehicle as described above, since the elements are mechanically coupled together, an output shaft of the motor-generator could be in negative rotation even if the engine has stopped. In such a case, driving the motor-generator so as to crank the engine could cause the motor-generator to generate electric power. The generation of electric power at this time is unintentional. Therefore, electric power could be generated beyond necessity.

An object of the present invention is to restrict the generation of electric power.

### Solution to Problem

In an embodiment, a vehicle includes: a switch to be operated by a driver; an internal combustion engine that is started by an operation of the switch; and an electric motor coupled to an output shaft of the internal combustion engine. When the switch is operated, the electric motor accelerates rotational speed of the output shaft of the internal combustion engine with a torque which decreases as a rotational speed of an output shaft of the electric motor increases.

In another embodiment, a control method for a vehicle that is equipped with a switch to be operated by a driver, an internal combustion engine that is started by an operation of the switch, and an electric motor coupled to an output shaft of the internal combustion engine, includes the steps of: determining whether or not the switch is operated; and accelerating, when the switch is operated, rotational speed of the output shaft of the internal combustion engine by the electric motor with a torque which decreases as a rotational speed of an output shaft of the electric motor increases.

In still another embodiment, a vehicle includes: a switch to be operated by a driver; an internal combustion engine that is started by an operation of the switch; and an electric motor coupled to an output shaft of the internal combustion engine. When the switch is operated, the electric motor accelerates rotational speed of the output shaft of the internal combustion engine with a speed which decreases as a rotational speed of an output shaft of the electric motor increases.

In yet another embodiment, a control method for a vehicle that is equipped with a switch to be operated by a driver, an internal combustion engine that is started by an operation of the switch, and an electric motor coupled to an output shaft of the internal combustion engine, includes the steps of: determining whether or not the switch is operated; and accelerating, when the switch is operated, rotational speed of the output shaft of the internal combustion engine by the electric motor with a speed which decreases as a rotational speed of an output shaft of the electric motor increases.

### Advantageous Effects of Invention

When a switch is operated so as to start an internal combustion engine, an electric motor accelerates the rotational speed of an output shaft of the internal combustion engine with a torque which decreases as a rotational speed of an output shaft of the electric motor increases. In a case where the rotation speed of the output shaft of the internal combustion engine is accelerated with a speed of change (rate of change) which decreases as a rotational speed of the output shaft of electric motor increases, the torque of the electric motor is reduced so as to reduce the speed of change. Thus, in both cases, a torque of the electric motor is reduced as a rotational speed of the output shaft of the electric motor increases. Therefore, the electric power generated by the electric motor is restricted when the output shaft of the electric motor is in negative rotation.

### BRIEF DESCRIPTION OF DRAWINGS

FIG. 1 is an overall block diagram of a vehicle.

FIG. 2 shows a nomographic chart (No. 1) of a power split device.

FIG. 3 is a functional block diagram of an ECU.

FIG. 4 shows a flowchart of a process carried out by the ECU.

FIG. 5 is an overall block diagram of a vehicle in another embodiment.

FIG. 6 shows an operation table for a C1 clutch, a C2 clutch, and a C3 clutch.

FIG. 7 shows a nomographic chart (No. 2) of a power split device.

FIG. 8 shows a nomographic chart (No. 3) of the power split device.

FIG. 9 shows a nomographic chart (No. 4) of the power split device.

FIG. 10 shows a nomographic chart (No. 5) of the power split device.

FIG. 11 shows a nomographic chart (No. 6) of the power split device.

### DESCRIPTION OF EMBODIMENTS

Embodiments of the present invention will be hereinafter described with reference to the drawings. In the following description, the same parts have the same reference signs allotted. They also have the same names and functions. Therefore, a detailed description thereof will not be repeated.

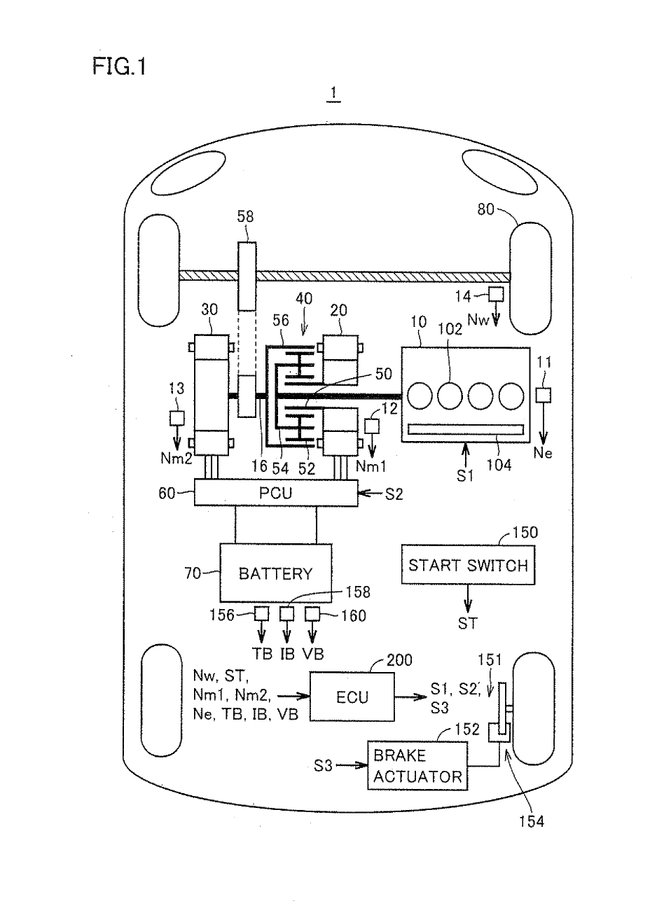

Referring to FIG. 1, an overall block diagram of a vehicle 1 according to the present embodiment will be described. Vehicle 1 includes an engine 10, a drive shaft 16, a first motor-generator (hereinafter referred to as first MG) 20, a second motor-generator (hereinafter referred to as second MG) 30, a power split device 40, a speed reducer 58, a PCU (Power Control Unit) 60, a battery 70, drive wheels 80, a start switch 150, a braking device 151, and an ECU (Electronic Control Unit) 200.

Vehicle 1 as above travels on driving force output from at least one of engine 10 and second MG 30. Motive power generated by engine 10 is split by power split device 40 into two paths. Of the two paths, one is a path for transfer via speed reducer 58 to drive wheels 80, and the other is a path for transfer to first MG 20.

First MG 20 and second MG 30 are, for example, three-phase AC rotating electric machines. First MG 20 and second MG 30 are driven by PCU 60.

First MG 20 has a function as a generator which generates electric power using motive power of engine 10 split by power split device 40, to charge battery 70 via PCU 60. In addition, receiving electric power from battery 70, first MG 20 rotates a crankshaft of engine 10 which serves as an output shaft. First MG 20 thereby has a function as a starter which starts engine 10.

Second MG 30 has a function as a drive motor which provides driving force for drive wheels 80 using at least any one of electric power stored in battery 70 and electric power generated by first MG 20. In addition, second MG 30 has a function as a generator for charging battery 70 via PCU 60 with the use of electric power generated through regenerative braking.

Engine 10 is, for example, an internal combustion engine such as a gasoline engine and a diesel engine. Engine 10 includes a plurality of cylinders 102 and a fuel injection device 104 which supplies fuel to each of the plurality of cylinders 102. Based on a control signal S1 from ECU 200, fuel injection device 104 injects an appropriate amount of fuel for each cylinder with appropriate timing and stops injecting fuel for each cylinder.

For the detection of the rotational speed of the crankshaft of engine 10 (hereinafter referred to as engine rotational speed) Ne, engine 10 is further provided with an engine rotational speed sensor 11. Engine rotational speed sensor 11 transmits a signal indicating detected engine rotational speed Ne to ECU 200.

Power split device 40 mechanically couples together three elements for rotating drive wheels 80: drive shaft 16, the output shaft of engine 10, and a rotation shaft (output shaft) of first MG 20. Power split device 40 utilizes any one of the above-indicated three elements as a reaction force element, thereby allowing for the transfer of motive power between the other two elements. A rotation shaft (output shaft) of second MG 30 is coupled to drive shaft 16.

Power split device 40 is a planetary gear mechanism including a sun gear 50, pinion gears 52, a carrier 54, and a ring gear 56. Pinion gear 52 engages with each of sun gear 50 and ring gear 56. Carrier 54 supports pinion gears 52 in a manner to allow them to rotate, and is coupled to the crankshaft of engine 10. Sun gear 50 is coupled to the rotation shaft of first MG 20. Ring gear 56 is coupled via drive shaft 16 to the rotation shaft of second MG 30 and speed reducer 58.

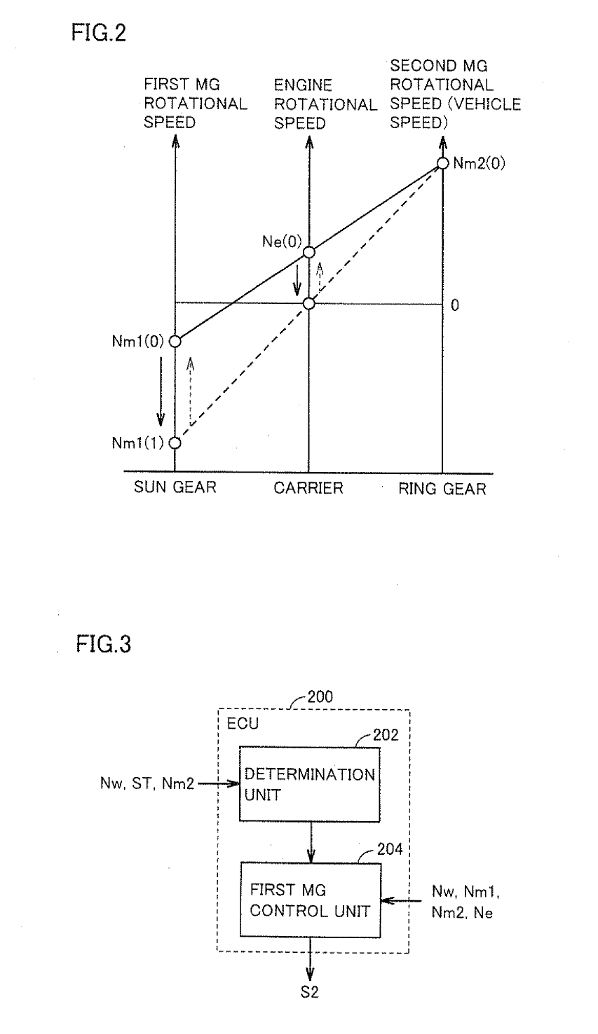

Since engine 10, first MG 20, and second MG 30 are coupled together by power split device 40, rotational speed Nm1 of first MG 20, engine rotational speed Ne, and rotational speed Nm2 of second MG 30 vary in such a manner that rotational speed Nm1, Ne, and Nm2 of these elements maintain such a relation that they are connected by a straight line in a nomographic chart of FIG. 2.

Of three vertical axes of the nomographic chart shown in FIG. 2, the left vertical axis indicates the rotational speed of sun gear 50, that is, rotational speed Nm1 of first MG 20. The center vertical axis of the nomographic chart shown in FIG. 2 indicates the rotational speed of carrier 54, that is, engine rotational speed Ne. The right vertical axis of the nomographic chart shown in FIG. 2 indicates the rotational speed of ring gear 56, that is, rotational speed Nm2 of second MG 30. It is noted that the direction of an arrow formed by each vertical axis of the nomographic chart of FIG. 2 indicates a positive rotational direction, and a direction opposite to the direction of the arrow indicates a negative rotational direction.

For instance, as a solid line in FIG. 2 shows, it is assumed that vehicle 1 is at first MG 20 rotational speed Nm1 of Nm1(0), engine rotational speed Ne of Ne(0), and second MG 30 rotational speed Nm2 of Nm2(0).

Power split device 40 rotates the rotational shaft of first MG 20 even when the vehicle is running and engine 10 has stopped. When the system of vehicle 1 is brought into a stop state while vehicle 1 is traveling at high speed, stopping fuel injection for engine 10 causes engine rotational speed Ne to decrease to zero. At this time, as a broken line in FIG. 2 shows, rotational speed Nm1 of first MG 20 increases in the negative rotational direction from Nm1(0) to Nm1(1). Therefore, as a vehicle speed increases, a rotational speed Nm1 of first MG 20 when engine rotational speed Ne becomes zero (when rotation of engine 10 has stopped) may increase.

It is assumed that first MG 20 is used to start engine 10 when vehicle 1 is traveling and engine rotational speed Ne is zero. In this case, it is necessary to increase engine rotational speed Ne by moving rotational speed Nm1 of first MG 20 upward from Nm1(1) (the broken line in FIG. 2) to Nm1(0) (the solid line in FIG. 2).

Upon generation of torque in the positive rotational direction, which is opposite to the rotational direction of first MG 20 (the negative rotational direction) so as to increase the rotational speed of first MG 20 from Nm1(1) to Nm1(0), since first MG 20 is rotating in the negative direction, first MG 20 generates electric power. In the present embodiment, the electric power generated by first MG 20 in cranking engine 10 is restricted as will be described later.

Referring back to FIG. 1, speed reducer 58 transfers motive power from power split device 40 and second MG 30 to drive wheels 80. In addition, speed reducer 58 transfers reaction force received by drive wheels 80 from a road surface, to power split device 40 and second MG 30.

PCU 60 converts DC power stored in battery 70 into AC power for driving first MG 20 and second MG 30. PCU 60 includes a converter and an inverter (both not shown) which are controlled based on a control signal S2 from ECU 200. The converter boosts a voltage of DC power received from battery 70 and outputs the boosted power to the inverter. The inverter converts the DC power output by the converter into AC power and outputs it to first MG 20 and/or second MG 30. First MG 20 and/or second MG 30 are thereby driven with the use of the electric power stored in battery 70. In addition, the inverter converts AC power generated by first MG 20 and/or second MG 30 into DC power and outputs its to the converter. The converter steps down a voltage of the DC power output by the inverter and outputs the stepped down power to battery 70. Battery 70 is thereby charged with the use of the electric power generated by first MG 20 and/or second MG 30. It is noted that the converter may be omitted.

Battery 70 is a power storage device and a rechargeable DC power supply. As battery 70, for example, a secondary battery such as a nickel-metal hydride secondary battery and a lithium ion secondary battery is used. Battery 70 has a voltage of the order of 200 V, for example. Battery 70 may be charged, other than with the use of the electric power generated by first MG 20 and/or second MG 30 as described above, with the use of electric power supplied from an external power supply (not shown). It is noted that battery 70 is not limited to a secondary battery, and may be anything that can generate a DC voltage, such as a capacitor, a solar cell, and a fuel cell, for example.

Battery 70 is provided with a battery temperature sensor 156 for detecting battery temperature TB of battery 70, a current sensor 158 for detecting current IB of battery 70, and a voltage sensor 160 for detecting a voltage VB of battery 70.

Battery temperature sensor 156 transmits a signal indicating battery temperature TB to ECU 200. Current sensor 158 transmits a signal indicating current IB to ECU 200. Voltage sensor 160 transmits a signal indicating voltage VB to ECU 200.

Start switch 150 is, for example, a push switch. Start switch 150 may be one that allows a key to be inserted into a key cylinder and rotated to a predetermined position. Start switch 150 is connected to ECU 200. In response to an operation of start switch 150 by a driver, start switch 150 transmits a signal ST to ECU 200.

ECU 200 determines that a start command is received when, for example, signal ST is received while the system of vehicle 1 is in the stop state, and then ECU 200 shifts the system of vehicle 1 from the stop state to a startup state. In addition, ECU 200 determines that a stop command is received when signal ST is received while the system of vehicle 1 is in the startup state, and then ECU 200 shifts the system of vehicle 1 from the startup state to the stop state. In the following descriptions, an operation of start switch 150 by a driver when the system of vehicle 1 is in the startup state will be referred to as an IG OFF operation, and an operation of start switch 150 by a driver when the system of vehicle 1 is in the stop state will be referred to as an IG ON operation. Once the system of vehicle 1 shifts to the startup state, for example, a plurality of pieces of equipment necessary for vehicle 1 to travel are supplied with electric power, so that the system enters an operable state. In contrast, once the system of vehicle 1 shifts to the stop state, for example, part of the plurality of pieces of equipment necessary for vehicle 1 to travel are no longer supplied with electric power, so that the system enters an operation stop state.

A first resolver 12 detects rotational speed Nm1 of first MG 20. First resolver 12 transmits a signal indicating detected rotational speed Nm1 to ECU 200. A second resolver 13 detects rotational speed Nm2 of second MG 30. Second resolver 13 transmits a signal indicating detected rotational speed Nm2 to ECU 200.

A wheel speed sensor 14 detects rotational speed Nw of drive wheel 80. Wheel speed sensor 14 transmits a signal indicating detected rotational speed Nw to ECU 200. ECU 200 calculates vehicle speed V based on rotational speed Nw received. It is noted that ECU 200 may calculates vehicle speed V based on rotational speed Nm2 of second MG 30 instead of rotational speed Nw.

Braking device 151 includes a brake actuator 152 and a disk brake 154. Disk brake 154 includes a brake disk which rotates integrally with the wheel and a brake caliper which restricts rotation of the brake disk using hydraulic pressure. The brake caliper includes brake pads which is provided in a manner to sandwich the brake disk in a direction parallel to the axis of rotation, and a wheel cylinder for transferring hydraulic pressure to the brake pads. Based on a control signal S3 received from ECU 200, brake actuator 152 regulates hydraulic pressure to be supplied to the wheel cylinder by regulating hydraulic pressure which is created by depression of a brake pedal by a driver and hydraulic pressure which is created with the use of a pump and an electromagnetic valve. Although FIG. 1 shows braking device 151 only at the right rear wheel, braking device 151 is provided for each wheel.

ECU 200 generates control signal S1 for controlling engine 10 and outputs generated control signal S1 to engine 10. Further, ECU 200 generates control signal S2 for controlling PCU 60, and outputs generated control signal S2 to PCU 60. Still further, ECU 200 generates control signal S3 for controlling brake actuator 152, and outputs generated control signal S3 to brake actuator 152.

By controlling engine 10, PCU 60, and the like, ECU 200 controls the entire hybrid system, that is, a state of charging/discharging of battery 70 and states of operation of engine 10, first MG 20, and second MG 30 such that vehicle 1 can travel most efficiently.

ECU 200 calculates requested driving force which corresponds to an amount of depression of an accelerator pedal (not shown) provided at a driver's seat. According to the calculated requested driving force, ECU 200 controls torque of first MG 20 and second MG 30 and an output of engine 10.

Vehicle 1 having a configuration as described above travels solely on second MG 30 when engine 10 is inefficient at the start of traveling or during low-speed traveling. In addition, during normal traveling, for example, power split device 40 divides motive power of engine 10 into two paths of motive power. Motive power in one path directly drives drive wheels 80. Motive power in the other path drives first MG 20 to generate electric power. At this time, ECU 200 uses generated electric power to drive second MG 30. In this way, by driving second MG 30, assistance in driving drive wheels 80 is provided.

When vehicle 1 reduces its speed, regenerative braking is performed with second MG 30, which follows the rotation of drive wheels 80, functioning as a generator. The electric power recovered through regenerative braking is stored in battery 70. It is noted that when remaining capacitance (hereinafter referred to as SOC (State of Charge)) of the power storage device has lowered and is in particular need of charging, ECU 200 increases an output of engine 10 to increase an amount of electric power generated by first MG 20. The SOC of battery 70 is thereby increased. In addition, even during low-speed traveling, ECU 200 may exert control for increasing driving force from engine 10 as necessary, for example, such as when battery 70 is in need of charging as described above, when auxiliary machinery such as an air conditioner is to be driven, and when the temperature of cooling water for engine 10 is to be raised to a predetermined temperature.

In controlling amounts of charging and discharging of battery 70, ECU 200 sets, based on battery temperature TB and the current SOC, allowable input power in charging battery 70 (hereinafter referred to as “charge power upper limit value Win”) and allowable output power in discharging battery 70 (hereinafter referred to as “discharge power upper limit value Wout”). For instance, as the current SOC gets lower, discharge power upper limit value Wout is gradually set lower. In contrast, as the current SOC gets higher, charge power upper limit value Win is gradually set lower.

In addition, the secondary battery used as battery 70 has temperature dependence that causes an increase in internal resistance at low temperatures. In addition, at high temperatures, it is necessary to prevent an over increase in temperature caused by further heat generation. It is therefore preferable to lower each of discharge power upper limit value Wout and charge power upper limit value Win when battery temperature TB is low and when battery temperature TB is high. ECU 200 sets charge power upper limit value Win and discharge power upper limit value Wout according to battery temperature TB and the current SOC, for example, through the use of a map or the like.

In the present embodiment, when first MG 20 is used to start engine 10 while vehicle 1 is traveling, the torque of first MG 20 is restricted such that electric power generated by first MG 20 is less than charge power upper limit value Win.

FIG. 3 shows a functional block diagram of ECU 200 mounted on vehicle 1 according to the present embodiment. ECU 200 includes a determination unit 202 and a first MG control unit 204.

Determination unit 202 determines whether or not an IG ON operation is performed. Determination unit 202 determines that an IG ON operation is performed when, for example, signal ST is received from start switch 150 while the system of vehicle 1 is in the stop state. It is noted that determination unit 202 may, for example, turn an IG ON determination flag on when an IG ON operation is performed.

Further, determination unit 202 determines whether or not vehicle 1 is traveling. Determination unit 202 determines that vehicle 1 is traveling when vehicle speed V is higher than a predetermined vehicle speed V(0). It is noted that determination unit 202 may turn a travel determination flag on when it is determined that vehicle 1 is traveling.

Upon determination by determination unit 202 that an IG ON operation is performed, that is, upon an operation of start switch 150 by a driver, first MG control unit 204 controls first MG 20 such that first MG 20 accelerates engine rotational speed Ne with a torque which decreases as a rotational speed Nm1 of the rotation shaft of first MG 20 increases. In other words, upon an operation of start switch 150, first MG 20 accelerates engine rotational speed Ne with a speed which decreases as a rotational speed Nm1 of the rotation shaft of first MG 20 increases. More specifically, first MG 20 is controlled to generate a torque in the positive rotational direction which decreases as a vehicle speed increases. As described above, torque of first MG 20 is restricted such that electric power generated by first MG 20 is less than charge power upper limit value Win.

For instance, assume that first MG 20 has torque Tm1(v0) when cranking engine 10 in a state where, for example, the vehicle speed is zero. If driving first MG 20 with Tm1(v0) under circumstances where the vehicle speed is higher than zero causes electric power generated by first MG 20 to exceed charge power upper limit value Win, then the torque of first MG 20 is set lower than Tm1(v0). The torque of first MG 20 is reduced to the point where electric power generated by first MG 20 is less than charge power upper limit value Win.

It is noted that electric power generated by first MG 20 can be calculated by employing well known techniques such as calculation from a map employing torque and rotational speed as parameters, and therefore, a detailed description of a calculation method thereof will not be repeated. Likewise, as to a method of controlling the torque of first MG 20, well known techniques can be employed.

In the present embodiment, although both determination unit 202 and first MG control unit 204 are described as realized through execution of a program stored in a memory by a CPU of ECU 200 and as functioning as software, they may be realized by hardware. It is noted that such a program is recorded in a storage medium for installation in the vehicle.

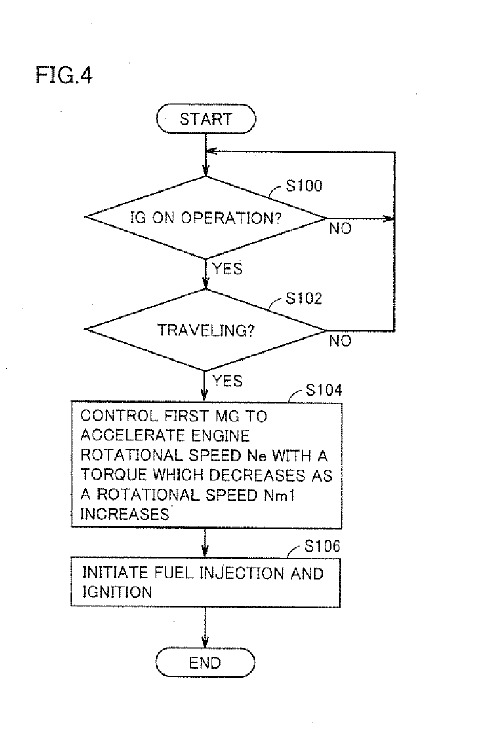

Referring to FIG. 4, a process to be carried out at ECU 200 mounted on vehicle 1 according to the present embodiment will be described.

In step (hereinafter step will be referred to as S) 100, ECU 200 determines whether or not an IG ON operation is performed. If an IG ON operation is performed (YES in S100), then in S102, ECU 200 determines whether or not vehicle 1 is traveling.

If vehicle 1 is traveling (YES in S102), then in S104, ECU 200 controls first MG 20 such that first MG 20 accelerates engine rotational speed Ne with a torque which decreases as a rotational speed Nm1 of the rotation shaft of first MG 20 increases.

Electric power generated by first MG 20 in association with increasing engine rotational speed Ne when starting engine 10 is thereby restricted. Therefore, it is possible to protect electrical equipment such as first MG 20 from heat generation and to protect battery 70 from overcharging.

Subsequently, once engine rotational speed Ne is sufficiently increased, in S106, ECU 200 controls engine 10 such that engine 10 initiates fuel injection and ignition. That is, engine 10 is started.

As above, in the present embodiment, first MG 20 accelerates an engine rotational speed with a torque which decreases as a rotational speed Nm1 of first MG 20 increases. Hence, electric power generated by first MG 20 is restricted when first MG 20 is in negative rotation in starting engine 10.

### Another Embodiment

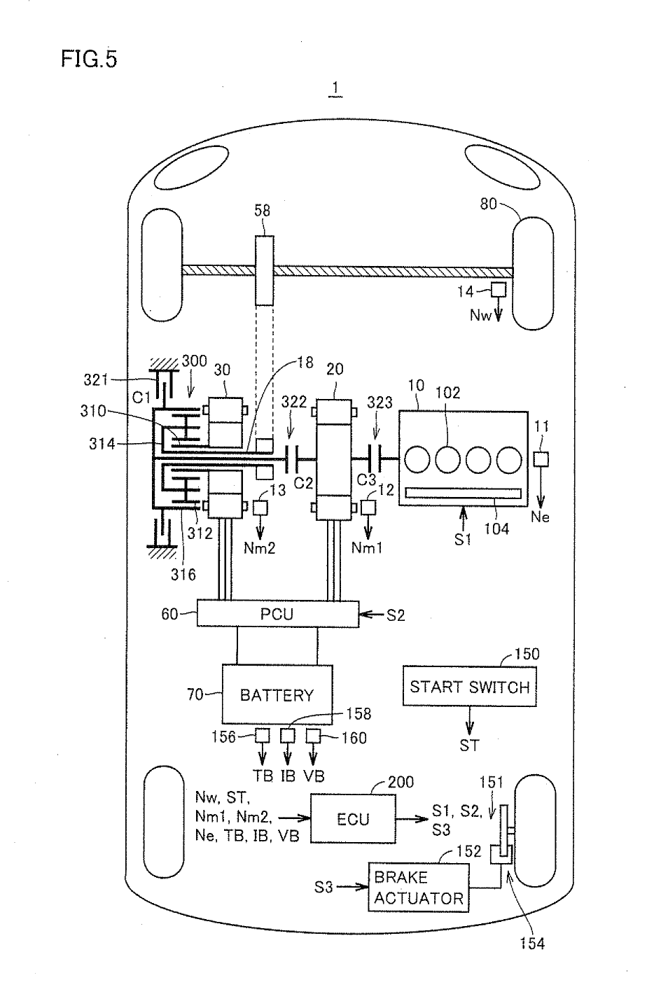

An embodiment using a power split device 300 which differs in form from the aforementioned power split device 40 will be hereinafter described. As shown in FIG. 5, a planetary gear mechanism which serves as power split device 300 and includes a sun gear 310, pinion gears 312, a carrier 314, and a ring gear 316 is mounted on vehicle 1 of the present embodiment.

Sun gear 310 is coupled to a rotation shaft of second MG 30. Pinion gear 312 engages with each of sun gear 310 and ring gear 316. Carrier 314 supports pinion gears 312 in a manner to allow them to rotate, and is coupled to speed reducer 58 via a drive shaft 18.

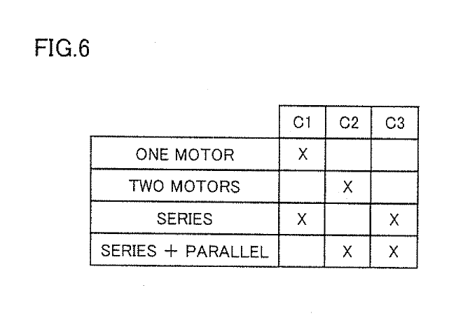

The state of ring gear 316 is controlled by a C1 clutch 321, a C2 clutch 322, and a C3 clutch 323. FIG. 6 shows an operation table for C1 clutch 321, C2 clutch 322, and C3 clutch 323.

In FIG. 6, “ONE MOTOR” means a control mode in which the vehicle travels using only one motor-generator as a drive source. “TWO MOTORS” means a control mode in which the vehicle travels using two motor-generators as a drive source. “SERIES” means a control mode in which vehicle 1 is provided with functions as a series hybrid vehicle. “SERIES+PARALLEL” means a control mode in which vehicle 1 is provided with functions as a series hybrid vehicle and functions as a parallel hybrid vehicle. “X” means “in an engaged state”.

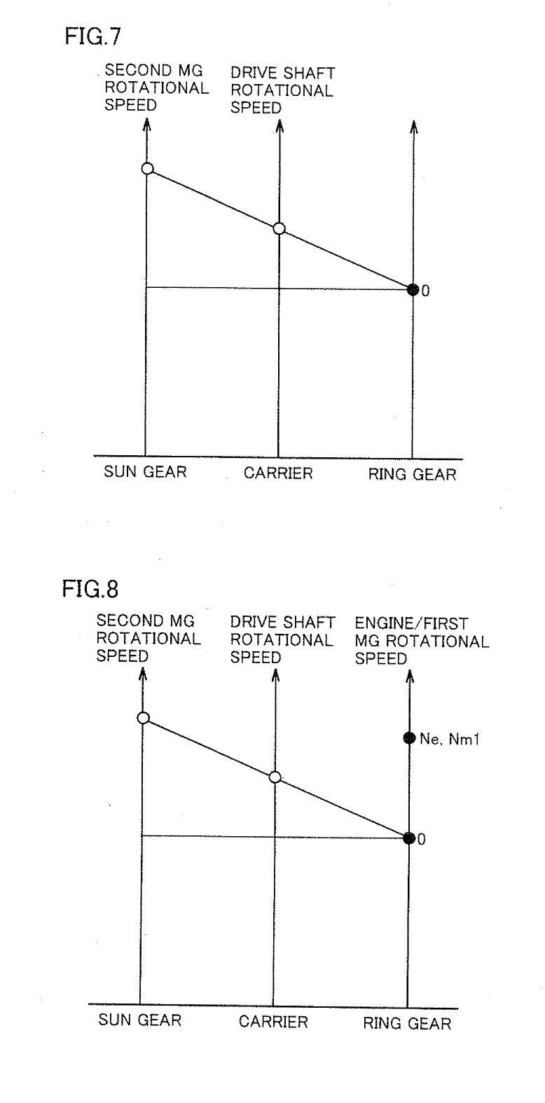

Ring gear 316 is secured in unrotatable manner when C1 clutch 321 is engaged, C2 clutch 322 is disengaged, and C3 clutch 323 is disengaged. That is, as shown in a nomographic chart of FIG. 7, the rotational speed of ring gear 316 is zero. In this state, vehicle 1 travels using only second MG 30 as a drive source.

When C1 clutch 321 is engaged, C2 clutch 322 is disengaged, and C3 clutch 323 is engaged, as shown in a nomographic chart of FIG. 8, vehicle 1 can travel using second MG 30 as a motive power source while generating electric power with first MG 20.

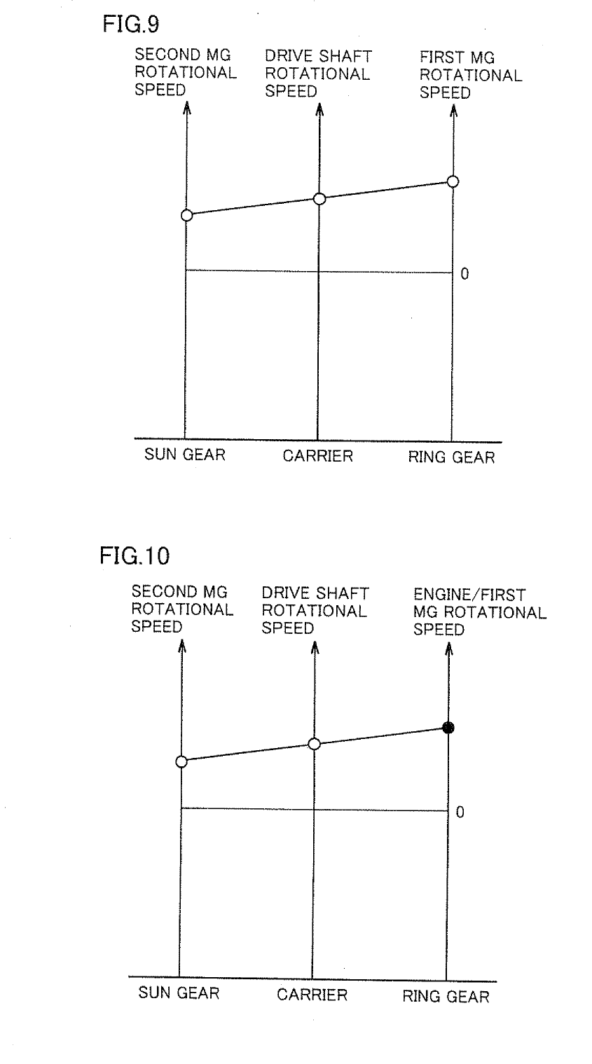

Ring gear 316 is coupled to first MG 20 when C1 clutch 321 is disengaged, C2 clutch 322 is engaged, and C3 clutch 323 is disengaged. As shown in a nomographic chart of FIG. 9, in this state, vehicle 1 can travel using first MG 20 and second MG 30 as a drive source.

Ring gear 316 is coupled to first MG 20 and engine 10 when C1 clutch 321 is disengaged, C2 clutch 322 is engaged, and C3 clutch 323 is engaged. As shown in a nomographic chart of FIG. 10, in this state, vehicle 1 can travel using engine 10 and second MG 30 as a drive source while generating electric power with first MG 20.

Of three vertical axes of the nomographic charts shown in FIGS. 7-10, the left vertical axis indicates the rotational speed of sun gear 310, that is, rotational speed Nm2 of second MG 20. The center vertical axis indicates the rotational speed of carrier 314, that is, rotational speed Nout of drive shaft 18. The right vertical axis indicates the rotational speed of ring gear 316. The rotational speed of ring gear 316 may be the same as rotational speed Ne of engine 10 or rotational speed Nm1 of first MG 20.

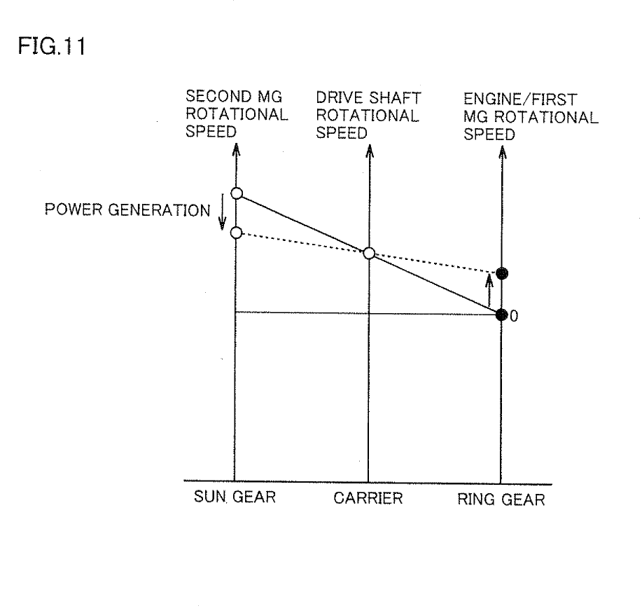

When C1 clutch 321 is disengaged, C2 clutch 322 is engaged, and C3 clutch 323 is engaged, for example, on a downhill or the like, it is possible for second MG 30 to output torque in the negative rotational direction thereby to increase engine rotational speed Ne from zero, as shown in FIG. 11.

That is, it is possible for second MG 30 to generate electric power thereby to increase engine rotational speed Ne so as to start engine 10. In a state where engine 10 has stopped, the higher the rotational speed of drive shaft 18, i.e., the vehicle speed is, the higher is rotational speed Nm2 of second MG 30.

In consideration of a fact that as a vehicle speed increases, a rotational speed Nm2 of second MG 30 increases, second MG 30 is controlled to accelerate engine rotational speed Ne with a torque which decreases as a vehicle speed increases. That is, second MG 30 accelerates engine rotational speed Ne with a torque which decreases as a rotational speed Nm1 of second MG 30 increases. Electric power generated by second MG 30 is thereby restricted.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1 vehicle; 10 engine; 11 engine rotational speed sensor; 12 first resolver; 13 second resolver; 14 wheel speed sensor; 16 drive shaft; 18 drive shaft; 20 first MG; 30 second MG; 40 power split device; 50 sun gear; 52 pinion gear; 54 carrier; 56 ring gear; 58 speed reducer; 70 battery; 80 drive wheel; 102 cylinder; 104 fuel injection device; 150 start switch; 156 battery temperature sensor; 158 current sensor; 160 voltage sensor; 200 ECU; 202 determination unit; 204 first MG control unit; 300 power split device; 310 sun gear; 312 pinion gear; 314 carrier; 316 ring gear; 321 C1 clutch; 322 C2 clutch; 323 C3 clutch.

1. A vehicle comprising:
a switch to be operated by a driver;
an internal combustion engine that is started by an operation of said switch; and
an electric motor coupled to an output shaft of said internal combustion engine, wherein
when said switch is operated during traveling, said electric motor accelerates rotational speed of the output shaft of said internal combustion engine with a torque which decreases as a rotational speed of an output shaft of said electric motor increases.

2. The vehicle according to claim 1, further comprising a coupling device coupling the output shaft of said internal combustion engine and the output shaft of said electric motor, wherein
said coupling device rotates the output shaft of said electric motor in a state where said vehicle is traveling and said internal combustion engine has stopped.

3. The vehicle according to claim 2, wherein
as a vehicle speed increases, said coupling device increases rotational speed of the output shaft of said electric motor, and
when said switch is operated, said electric motor accelerates rotational speed of the output shaft of said internal combustion engine with a torque which decreases as a vehicle speed increases.

4. The vehicle according to claim 3, wherein
said coupling device includes a sun gear, a carrier, and a ring gear,
said sun gear is coupled to the output shaft of said electric motor,
said carrier is coupled to the output shaft of said internal combustion engine, and
said ring gear is coupled to wheels.

5. The vehicle according to claim 1, wherein
torque of said electric motor is restricted such that electric power generated by said electric motor is less than a predetermined upper limit value.

6. A control method for a vehicle that is equipped with a switch to be operated by a driver, an internal combustion engine that is started by an operation of said switch, and an electric motor coupled to an output shaft of said internal combustion engine, the method comprising the steps of:
determining whether or not said switch is operated; and
accelerating, when said switch is operated while said vehicle is traveling, rotational speed of the output shaft of said internal combustion engine by said electric motor with a torque which decreases as a rotational speed of an output shaft of said electric motor increases.

7. A vehicle comprising:
a switch to be operated by a driver;
an internal combustion engine that is started by an operation of said switch; and
an electric motor coupled to an output shaft of said internal combustion engine, wherein
when said switch is operated during traveling, said electric motor accelerates rotational speed of the output shaft of said internal combustion engine with a speed which decreases as a rotational speed of an output shaft of said electric motor increases.

8. A control method for a vehicle that is equipped with a switch to be operated by a driver, an internal combustion engine that is started by an operation of said switch, and an electric motor coupled to an output shaft of said internal combustion engine, the method comprising the steps of:
determining whether or not said switch is operated; and
accelerating, when said switch is operated while said vehicle is traveling, rotational speed of the output shaft of said internal combustion engine by said electric motor with a speed which decreases as a rotational speed of an output shaft of said electric motor increases.
